(19) United States
(12) Patent Application Publication
(10) Pub. No.: US 2002/0026723 A1
(43) Pub. Date: Mar. 7, 2002

(54) Adjustable dual-use clip for a chalk line

(76) Inventor: Joseph M. Savalla, Rockford, IL (US)

Correspondence Address: KEITH FRANTZ, 401 WEST STATE STREET, SUITE 200, ROCKFORD, IL, 61101

(21) Appl. No.: 09/938,810

(22) Filed: Aug. 24, 2001

Related U.S. Application Data
(60) Provisional application No. 60/227,637, filed on Aug. 24, 2000.

(51) Int. Cl. B44D 3/38

(52) U.S. Cl. 33/414; 33/758

(57) ABSTRACT

A chalk line is provided with an adjustable clip that is adapted for positive gripping connection to an edge for drawing the chalk coated string line across the board. The adjustable clip includes a pair of opposing gripping jaws that are spring biased closed and manually operable for clipping onto the edge of the board. The clip also includes a hook and eyelet for alternate use as a conventional chalk line.

### CROSS-REFERENCE TO RELATED APPLICATION

This application claims the benefit of U.S. Provisional Patent Application Ser. No. 60/227,637 filed Aug. 24, 2000.

### REFERENCE TO MICROFICHE APPENDIX

not applicable.

### STATEMENT REGARDING FEDERALLY SPONSORED RESEARCH OR DEVELOPMENT

not applicable.

### BACKGROUND OF THE INVENTION

1. Field of Invention

The present invention relates generally to chalk lines of the type suitable for temporarily marking a board or drywall or other relatively flat member or surface with a straight chalk line marking.

More particularly the invention relates to chalk lines provided with an adjustable dual-use clip adapted for quickly and securely connecting to the edge of the board for ease of snapping a line at any desired angle.

2. Description of Prior Art

Conventional chalk lines comprise a string line coiled on a spool that is rotatably mounted in a housing partially filled with chalk powder. The free end of the line extends through a snug opening in the housing such that the line can be manually drawn from the housing for snapping a chalk line marking and can then be re-coiled into the housing for re-chalking of the line and for storage between uses.

Prior conventional chalk lines are typically provided with a hook at the free end of the string line for “hooking” over the edge of the board. (Reference herein to a “board” includes reference to any relatively flat member except where such inclusion would be contrary to such use and a plain reading thereof.) During use, the hook is positioned over an edge of the board, the chalked string is uncoiled from the housing and drawn taught over the board in the direction of the desired chalk line marking, after which the line is drawn away from the board and then let go such that the string snaps onto the surface of the board leaving a chalk marking along the line of contact therebetween.

If the desired chalk line marking is perpendicular to the edge over which the clip is hooked, the tension in the line will generally keep the hook in place while the line is snapped.

However, snapping a line at any other angle relative to the edge is more difficult and time consuming. If the string is drawn along an angle other than perpendicular to the edge, the hook tends to slip from the desired location. In addition, there are instances when a straight edge is not available such as attempting to hook over an outwardly curved edge. In either event, the hook tends to slip as the line is drawn taught prior to and/or during snapping thereof. To maintain the hook in the desired location, either one person must hold the clip in place while a second person draws and snaps the line, or a nail must be temporarily secured at the edge of the board for connecting the free end of the string. In the later instance, the nail must be removed after the line is snapped. Moreover, there are instances where it becomes extremely difficult to snap an angled line if a second person is not available. For example, it can be difficult to put a nail firmly at the edge of a piece of plywood that is very “springy”, or at the edge of a piece of drywall that tends to flake apart. In any event, use of the conventional prior chalk line for such “angled” lines results in inconvenience to the user, and additional labor and construction expense associated therewith.

Accordingly, it is apparent there is a need for a chalk line that eliminates the above-described disadvantages of prior conventional chalk lines when snapping angled lines. In particular, there is a need for a chalk line that connects quickly and firmly to the edges of a board regardless of the stiffness, material or configuration of the edge so as to eliminate the inconvenience and costs associated with use of prior conventional chalk lines for snapping angled lines.

### SUMMARY OF THE INVENTION

The general aim of the present invention is to provide a new and improved chalk line that is adapted to quickly, easily and firmly clip to the edge of a board regardless of the stiffness, material and configuration of the edge so as to enable line chalking at any desired angle and without the disadvantages of prior chalk lines.

A detailed objective is to achieve the foregoing by providing a chalk line with a spring-loaded adjustable clip adapted to releasably grip the edge of a board.

Another detailed objective of the invention is to provide a chalk line with an adjustable clip that is further adapted for use as a conventional chalk line hook.

Accordingly, the clip hereof provides a dual-use function, to be able to clip onto a board, as well as hook onto the board similar to conventional prior chalk lines, permitting snapping of a chalk line quicker and easier that with conventional chalk lines.

These and other objectives and advantages of the invention will become more apparent from the following detailed description when taken in conjunction with the accompanying drawings.

In a preferred embodiment, the chalk line is provided with a clip comprising a pair of opposing gripping jaws that are pivotally connected together for opening and closing, that are spring biased to the closed position, and that are provided with opposite free end portions for manually opening the jaws when squeezed together. With this arrangement, the clip is firmly connected to a convenient edge by simply squeezing the free end portions of the clip to open the jaws, positioning the clip with the edge of the board between the jaws, and releasing the clip such that the spring closes the jaws to grip the edge of the board.

### BRIEF DESCRIPTION OF THE DRAWINGS

FIG. 1 is a perspective view of a chalk line including a clip incorporating the unique aspects of the present invention connected to the edge of a board.

FIG. 2 is an enlarged perspective view of the clip of FIG. 1 shown in a closed position.

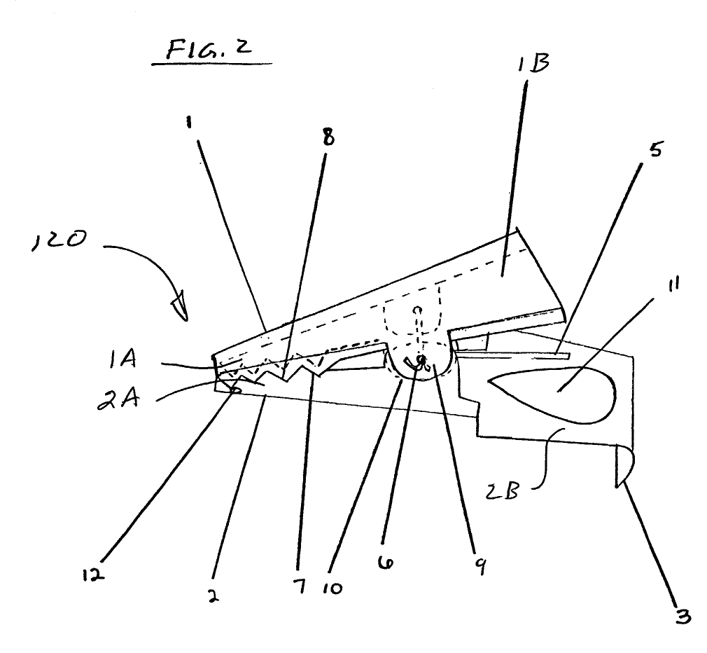

FIG. 3 is a side view of the clip in an open position.

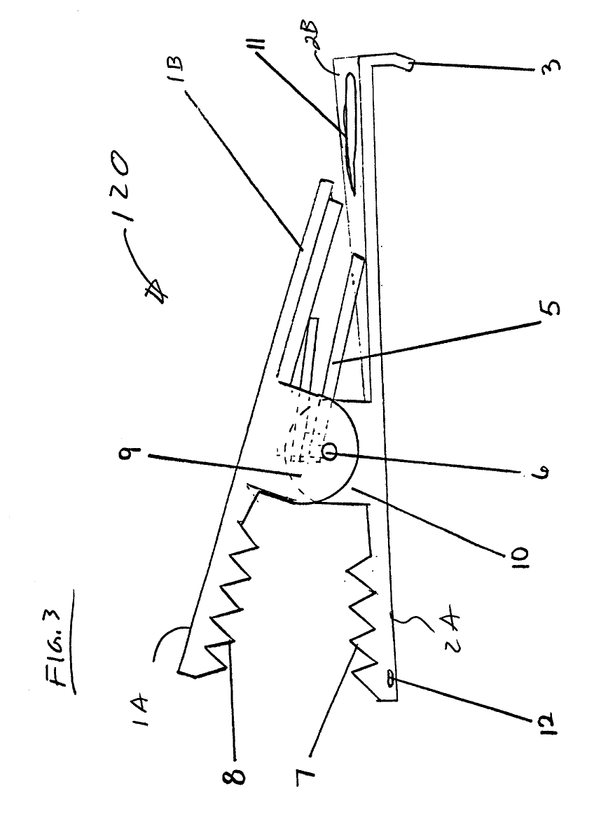

FIG. 4 is a bottom plan view of the clip.

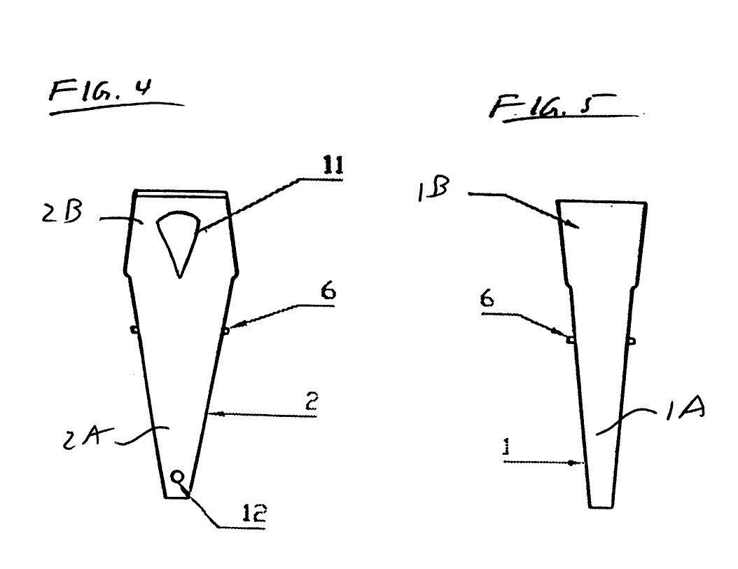

FIG. 5 is a top plan view of the clip.

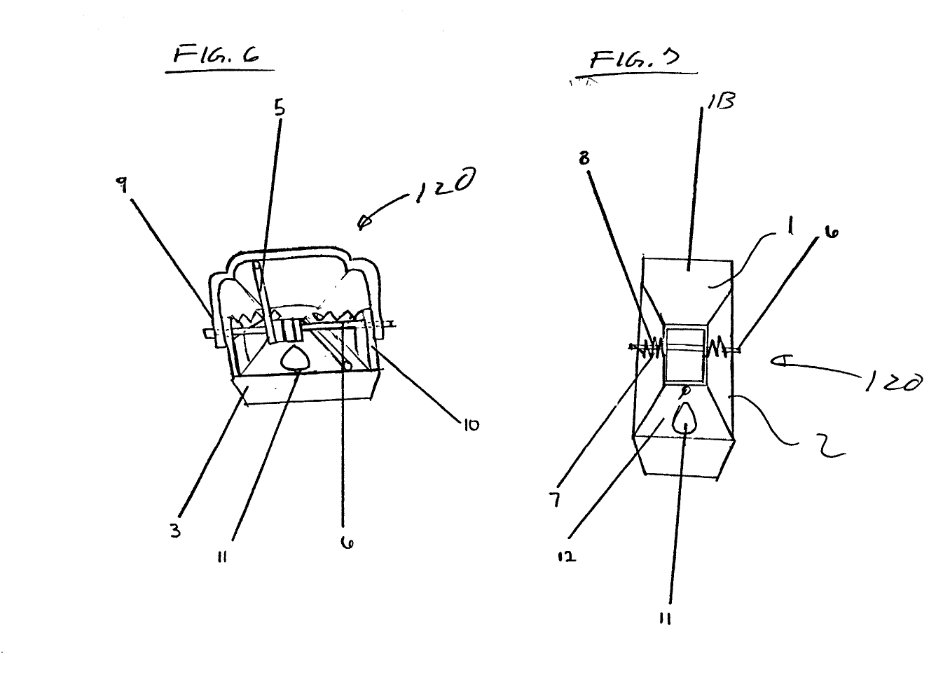

FIGS. 6 and 7 are front and rear views of the clip.

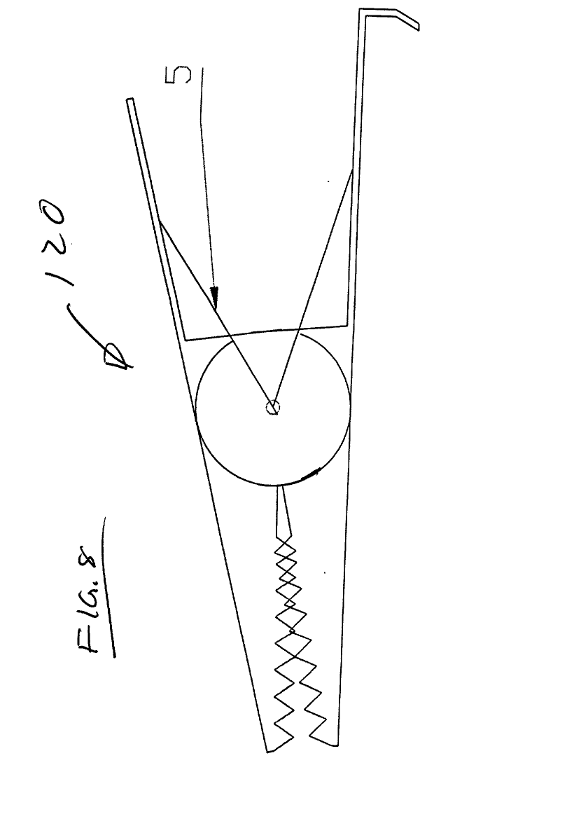

FIGS. 8 and 9 are side diagrammatic views of the clip in the closed and in an alternate open position.

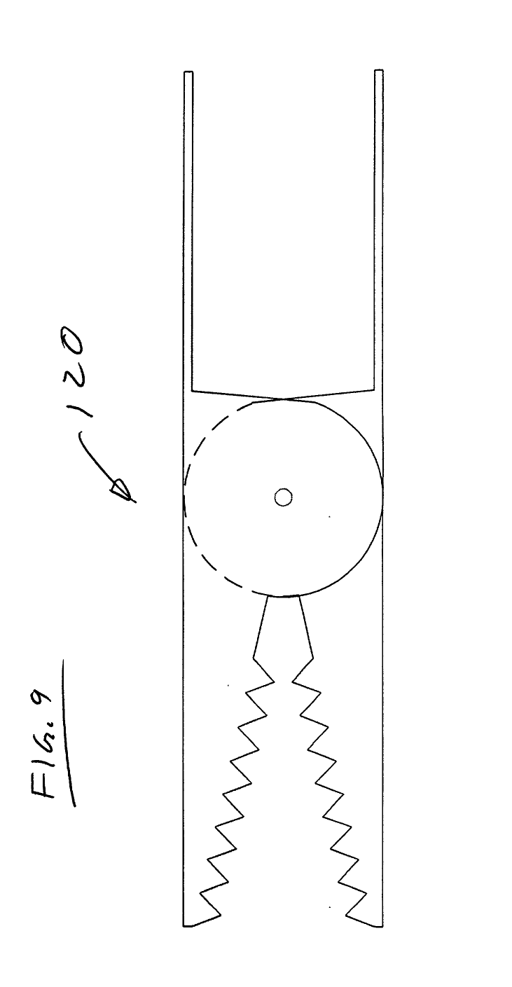

While the invention is susceptible of various modifications and alternative constructions, a certain illustrated embodiment has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DETAILED DESCRIPTION OF THE INVENTION

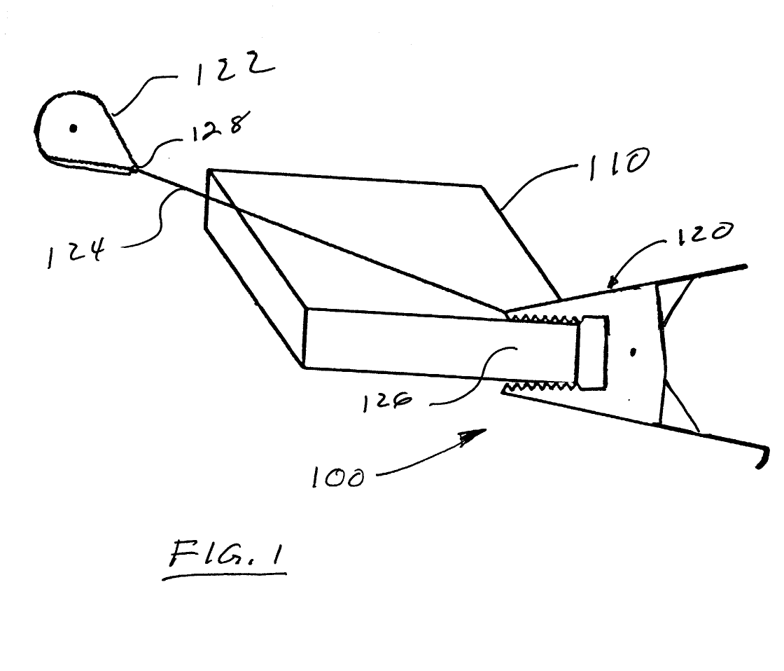

For purposes of illustration, the present invention is shown in the drawings in connection with a chalk line 100 (FIG. 1) for creating a temporary chalk line mark on a board 110.

Briefly, the chalk line 100 includes a string line 124 coiled on a spool (not shown) that is rotatably mounted in a housing 122 partially filled with chalk powder. The line 124 extends through a snug opening 128 in the housing, with the free end of the line passing through a hole 12 formed in the forward end of the clip 120 and being tied thereto.

To make the desired chalk line marking, the clip 120 is connected to the edge 126, the string line 124 is manually drawn from the housing 122 and over the board 110 in the direction of the desired marking (such as shown in FIG. 1), after which the line is pulled away from the board and then let go to snap onto the board and create the chalk line marking along the line of contact therebetween. After use, or for re-chalking, the string line 124 is drawn back into the housing, and wrapped around the spool with the assistance of a rotatable handle (not shown) connected thereto.

In accordance with the present invention, the clip 120 of the chalk line 100 is uniquely adapted for quick and easy, yet firm connection to any convenient edge of the board 110.

In carrying out one aspect of the invention, the clip 120 includes a pair of opposing clip members 1 and 2 that are adapted for releasably gripping the edge 126 of the board. The clip members 1 and 2 comprise gripping end portions 1A and 2A, preferably provided with teeth 7 and 8, respectively, and free end portions 1B and 2B opposite the gripping end portions. The clip members 1 and 2 are pivotally connected together with pin 6 generally centrally thereof. In the embodiment shown, the clip members 1 and 2 are provided with pairs of laterally spaced overlapping flaps 9 and 10, respectively, having aligned holes through which the pin 6 extends to define the hinge. A spring 5 is provided to bias the gripping ends of the clip members to the closed position. In the embodiment shown, a coil spring is held between the clip members by the pin 6 extending therethrough, the spring including free ends that engage the inside of the free end portions of the clip members to bias the clip closed.

With this arrangement, the normally closed clip 120 can be manually opened, by simply squeezing the free end portions 1B, 2B of the clip members, and then slipped onto the edge 126 of the board at the desired location. After the clip is released, with the teeth 7, 8 gripping the board to maintain the clip firmly as positioned, the string line 124 can be drawn out at any angle therefrom to snap the line without concern that the clip will slip.

In carrying out a second aspect of the invention, the clip 120 is adapted for alternate use similar to a conventional hook associated with prior conventional chalk lines. To this end, the handle portion 2B of the clip member 2 is formed with an L-shaped hook 3 at the free end thereof, with the hook extending away from the upper clip. As a result, if desired, the clip 120 can be simply hooked over the edge 126 in a conventional manner such as when edge is straight and extends generally perpendicular to the desired chalk line marking. Alternately, the clip can be hooked to a nail in the board with the teardrop shaped hole 11 in the clip member 2.

As will be apparent to those skilled in the art that numerous alternate embodiment clips will fall within the scope of the present innovation. By way of example only, a clip in accordance herewith may be provided with alternately configured gripping rather than gripping teeth. In the embodiment shown, the clip members 1 and 2 are of sheet metal construction, but be made in any suitable manner such from a casting or forging. The clip may be made from any suitable material, but is preferably made from durable, lightweight metal or resilient plastic suitable for use at construction sites. The clips can be provided of any convenient size, such as for standard thickness drywall and plywood and dimensional lumber. And alternate shapes, constructions and pivot connections are known and may be provided within the present invention.

From the foregoing, it will be apparent that the present invention brings to the art a new and improved chalk line with an adjustable due-use clip. In particular, the clip will out perform prior hooks with its dual function that allows straight lines as well as angle lines in an effortless, effective, and time efficient manner. Instead of the necessity of driving a nail or having a second person hold one end of the string or even going through the trouble of getting a straight edge and a pencil, the user can simply clip the dual-use chalk line clip at one point of the angle and place the other end on the mark and snap the line.

Accordingly, the dual-use clip according to the invention permits faster more productive work by eliminating the need for an extra person to snap angled lines or the need of for a straight edge. Moreover, the dual-use clip does not substantially change the size, weight or appearance of the conventional chalk line, and it use will be intuitively obvious to the user upon sight without further instruction.

I claim:

1. A chalk line comprising:
a housing adapted to hold powder chalk,
a coiled string line located in the housing, the string line extending through an opening formed in the housing and having a free end outwardly of the housing, the string line being adapted for drawing out from the housing and re-coiled back into the housing, and
a manually operable clip connected to the free end of the string line,
the clip including:
first and second opposing clip members each having a gripping end portion and a free end portion, and being pivotally connected together for manually opening and closing the gripping end portions by squeezing the free end portions toward one another, and
a spring biasing the gripping end portions of the clip members to the closed position.

2. A chalk line as defined in claim 1 in which the clip further includes a hook extending from one of said free end portions generally in a direction away from the other of said free end portions.
